(19) United States
(12) Patent Application Publication
(10) Pub. No.: US 2014/0207531 A1
(43) Pub. Date: Jul. 24, 2014

(54) Systems And Methods For Assessing Organizations Using User-Defined Criteria

(71) Applicant: Steeve Teong Sin Kay, Newport Coast, CA (US)

(72) Inventor: Steeve Teong Sin Kay, Newport Coast, CA (US)

(21) Appl. No.: 14/219,585

(22) Filed: Mar. 19, 2014

Related U.S. Application Data
(63) Continuation-in-part of application No. 13/838,109, filed on Mar. 15, 2013.
Application No. 13/838,109 is a continuation-in-part of application No. 13/409,078, filed on Feb. 29, 2012.
Application No. 13/409,078 is a continuation-in-part of application No. 13/189,374, filed on Jul. 22, 2011.
Application No. 13/189,374 is a continuation-in-part of application No. 13/038,281, filed on Mar. 1, 2011.

(51) Int. Cl. G06Q 10/06

(52) U.S. Cl. CPC G06Q 10/06393
USPC 705/7.39

(57) ABSTRACT

The present inventive subject matter is drawn to apparatus, systems, configurations, and methods of automatically assessing an organization using user-defined criteria. In one aspect of this invention, an organization assessment system is automatically configured to interface with one or more enterprise entities or other third party entities, track and store performance data related to the one or more enterprise entities, and present a composite score to users based on their user-defined criteria.

This application is a continuation-in-part of U.S. application Ser. No. 13/838,109, entitled “Performance Evaluation in a Project Management System,” filed Mar. 15, 2013, which is a continuation-in-part of U.S. application Ser. No. 13/409,078, entitled “Project Management System,” filed on Feb. 29, 2012, which is a continuation in part of U.S. application Ser. No. 13/189,374, entitled “Project Management System and Template,” filed on Jul. 22, 2011, which is a continuation-in-part of U.S. application Ser. No. 13/038,281, entitled “Project Management System,” filed on Mar. 1, 2011.

These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention is generally related to assessment of organizations. More particularly it relates to methods and systems for assessing and evaluating the performance of an organization in relation to different aspects.

### BACKGROUND

The following description includes information that may be useful in understanding the present invention. It is not an admission that any of the information provided herein is prior art or relevant to the presently claimed invention, or that any publication specifically or implicitly referenced is prior art.

There has always been a need to effectively assess and evaluate the performance of different organizations, such as, business enterprises, universities, non-profit organizations. These assessments allow different parties who have interest in the organizations (e.g., potential investors, potential partners, consumers, etc.) to gauge the desirability of these organizations before taking actions (e.g., investing in an organization, partnering with an organization, studying in a university, etc.). In fact, there are organizations (i.e., assessing companies) that are specialized in the assessing, evaluating, and/or ranking of other organizations. For example, Forbes® Magazine issues scores and rankings of the largest companies in the United States based on their financial performance (e.g., assets, liability, market capitals, etc.), U.S. News and Reports® issues scores and rankings of the top universities in the United States based on some aspects of the universities' performances, AM Best® provides ratings for insurance companies based on their financial strength, and Morningstar® provides scores and rankings for publicly traded companies based on their potential in stock price gains. In general, the higher the degree of sophistication and relevancy of the factors considered by the assessing companies, the more accurate is the assessment analysis.

Efforts have been put forth in providing automatic tools in assessing organizations. For example, U.S. patent application publication 2013/0179259 to Lindauer et al. titled “Computer-Implemented System and Method For Targeting Investors Compatible With A Company,” filed Jan. 6, 2012, discusses matching investors with “compatible” companies using a “compatibility score” which measures quantitative ratings data of the company. Potential investors would then be able to use this information to make more informed decisions with respect to investing in companies. However, the “compatibility scores” in Lindauer only takes into account a limited aspect of the company—the company's financial and investment abilities and strengths, and do not take into account other aspects of the companies (e.g., project management capabilities, etc.) that might be of interest to the potential investors.

U.S. Pat. No. 7,953,626 to Wright et al. titled “Systems and Methods for Assessing and Tracking Operational and Functional Performance,” filed Sep. 30, 2004, discusses methods of evaluating a company's operational and functional performance. Specifically, Wright identifies numerous areas of performance (e.g., numbers of customers' complaints, project completions, etc.) related to the quality of a company's operations and function. While the assessment tool provided in Wright is useful for internal tracking, it might not be as useful for other parties such as potential business partners.

Other examples of automated assessment tools include U.S. patent application publication 2013/0151316 to Stoica et al. titled “Methodology for Restoring the Sustainable Profitability of a Business Unit Through Operational and Process Re-Engineering (Operational Turnaround),” filed Dec. 11, 2011, that discusses evaluating a company's culture, U.S. patent application publication 2009/0276296 to Spriegel titled “Business Profit Resource Optimization System and Method,” filed May 1, 2008, that teaches evaluating employees of a company using information about characteristics that are related to employee values, work ethic, etc., U.S. Pat. No. 6,741,002 to Arrowood titled “Computer-Implemented and/or Computer-Assisted Web Database and/or Interaction System for Staffing of Personnel in Various Employment Related Fields,” filed Mar. 27, 2001, discusses evaluating and matching the personality of candidates and employees to the culture of a company.

Other publications dealt with the concept of a company's culture as well. For example, a publication by Boulder County Business Report, “Software helps companies fit their hires to their cultures,” by Elizabeth Gold, May 24, 2013 (www.bcbr.com/article/20130524/EDITION/130529951/). Gold teaches managing and monitoring a company's culture using statistics provided through different sources, such as worker surveys, etc. The collected data provided insight into the employee morale and working environment.

U.S. patent application publication 2005/0055229 to Jones titled “Automated Issue-Communication Method that Significantly Improves an Organization's Safety Culture and Corporate Forthrightness by Encouraging the Communication of Issues and Concerns, Circumventing Middle-Management Filters While Suppressing ‘Whistleblower’ Creation” discusses the evaluation of a company's culture of safety and security in relation to company operations, etc.

However, no matter how sophisticated the assessment tool is, it is still limited by the types of factors used in assessing the organizations. Especially in today's fast paced world, factors that are used to be relevant in making a decision might no longer be relevant now, and vice versa. In addition, different parties may have different criteria (and different from the ones used in the assessment tool) in evaluating organizations.

Thus, there is still a need for providing a better company assessment tool that allows different parties to effectively assess organizations in different manners.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to apparatus, systems, configurations, and methods of automatically assessing an organization using user-defined criteria. In one aspect of this invention, a system for assessing an organization is presented.

In some embodiments, the system for assessing an organization comprises a performance database configured to store performance data of the organization, and an assessment engine coupled to the performance database. The assessment engine of some embodiments may be configured to derive a first aspect score and a second aspect score for the organization based on the performance data. Each of the first and second aspect scores quantifies a different performance aspect of the organization. In other embodiments, the assessment engine may also be configured to: provide a user interface that allows a user to specify a weight for each performance aspect; generate a composite score for the organization by applying corresponding ones of the weights to each of the first and second aspect scores; and configure a display device to present the composite score to the user.

In some embodiments, it is contemplated that the system for assessing an organization may further comprise a standard database. The standard database may store one or more standards. In some embodiments, the user interface may allow the user to select one of the one or more standards stored in the standard database. The user selected standard may be utilized to derive the first aspect score and the second aspect score.

In some embodiments, the first aspect score quantifies a performance aspect of the organization with respect to a first stakeholder, and the second aspect score quantifies a performance aspect of the organization with respect to a second stakeholder different from the first stakeholder. In some of these embodiments, each of the first and second stakeholders may be selected from the following group of stakeholders: customers, vendors, employees, and shareholders.

In some embodiments, the user interface allows the user to select a weighting profile from a plurality of weighting profiles. Each weighting profile specifies weights for the different performance aspects. The plurality of weighting profiles of some embodiments includes a vendor weighting profile, a partnership weighting profile, a merger and acquisition weighting profile, and a customer weighting profile.

Also in some embodiments, the system for assessing an organization may be further configured to provide a second user interface that allows the user to specify first and second performance aspects from among the different performance aspects, to be quantified by the first and second aspect scores, respectively.

In another aspect of the invention, a method for assessing an organization using user-defined criteria is presented. In some embodiments, the method for assessing an organization using user-defined criteria includes the steps of providing a performance database configured to store performance data of the organization, and providing an assessment engine coupled to the performance database. The method also includes the step of deriving, by the assessment engine, a first aspect score and a second aspect score for the organization based on the performance data. Each of the first and second aspect scores quantifies a different performance aspect of the organization. The method further includes the steps of providing a user interface that allows a user to specify a weight for each performance aspect; generating a composite score for the organization by applying corresponding ones of the weights to each of the first and second aspect scores; and configuring a display device to present the composite score to the user.

In some embodiments, first aspect score quantifies a performance aspect of the organization with respect to a first stakeholder, and the second aspect score quantifies a performance aspect of the organization with respect to a second stakeholder different from the first stakeholder. Each of the first and second stakeholders, of some embodiments, may be selected from the following group of stakeholders: customers, vendors, employees, and shareholders.

The method of assessing an organization of some embodiments may further include a step of deriving, by the assessment engine, a third aspect score based on the performance data that quantifies a performance aspect of the organization with respect to a third stakeholder. The composite score may be further based on a weighting of the third aspect score. In some of these embodiments, the method may further include the step of deriving, by the assessment engine, a fourth aspect scores based on the performance data that quantifies a performance aspect of the organization with respect to a fourth stakeholder. The composite score may further be based on a weighting of the fourth aspect score. In yet some of these embodiments, the method further includes a step of deriving, by the assessment engine, a fifth aspect scores based on the performance data that quantifies a performance aspect of the organization with respect to a fifth stakeholder. The composite score may also be based on a weighting of the fifth aspect score.

In some embodiments, the first aspect score may be based on a first subset of the performance data, and the second aspect score may be based on a second subset of the performance data different from the first subset. In other embodiments, the performance data may include at least four of the following: financial data, customer satisfaction data, vendor satisfaction data, employee satisfaction data, electronic communication among employees, electronic communication between employees and vendors, electronic communication between employees and customers, and project tracking data.

In some embodiments, the performance database may be further configured to store performance data of a plurality of companies.

In some embodiments, the user interface may allow the user to select a weighting profile from a plurality of weighting profiles. Each weighting profile specifies weights for the different performance aspects. The plurality of weighting profiles of some of these embodiments may include a vendor weighting profile, a partnership weighting profile, a merger and acquisition weighting profile, and a customer weighting profile.

The method of assessing an organization using user-defined criteria, of some embodiments, may further include a step of providing a second user interface that allows the user to specify first and second performance aspects from among the different performance aspects, to be quantified by the first and second aspect scores, respectively. Also, in some embodiments, the method may further include a step of deriving, by the assessment engine, a first aspect score and a second aspect score for each organization in the plurality of companies. In these embodiments, the method may further include the steps of generating a composite score for each organization in the plurality of companies by applying the corresponding weight to each of the first and second aspect scores and combining a weighted first aspect score with a weighted second aspect score for each organization; ranking the plurality of companies according to the composite scores; and configuring a display device to present the ranking of the plurality of companies.

In another aspect of the invention, a method for assessing a performance of an organization is presented. In some embodiments, the method for assessing a performance of an organization includes a step of electronically tracking performance data of an organization. The method may further include the step of deriving, from the performance data, a first performance score quantifying a performance of the organization with respect to a first stakeholder; and deriving, from the performance data, a second performance score quantifying a performance of the organization with respect to a second different stakeholder. In some embodiments, the step of deriving the first performance score and the second performance score may be accomplished using a user specified standard. In other embodiments, the method may further include the steps of computing a composite performance index for the organization by applying a first weight to the first performance score and a second weight to the second performance score based on a weighted first score and a weighted second score; and configuring a display device to present the performance index to a user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example computing environment in which a system for assessing an organization is presented.

FIG. 2 illustrates an example performance data set for a business enterprise that may be retrieved by an organization assessment system.

FIG. 3 illustrates an example of an organization assessment system as utilized by a project manager to evaluate the project management methodology of an enterprise project workflow.

FIG. 4 illustrates a preferred embodiment of a method for assessing the performance of an organization.

FIG. 5 illustrates an example performance data set that may be retrieved by an organization assessment system for a sports franchise (i.e., a sports team).

FIG. 6 illustrates an example performance data set that may be retrieved by an organization assessment system for an educational institution (example, a university).

FIG. 7 illustrates a preferred embodiment of a process for assessing an organization using user-defined criteria.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The present inventive subject matter is drawn to apparatus, systems, configurations, and methods of automatically assessing an organization using user-defined criteria. In one aspect of this invention, a system for assessing an organization is presented. The organization assessment system provides a composite score for each organization. The composite score of an organization takes into account multiple performance aspects of the organization. In contrast to existing assessment systems, the organization assessment system of the present invention allows different users to provide input (e.g., input related to which aspect should be included, how important are the different aspects, etc.) in computing the composite score for the organizations, such that the composite scores are personalized to each user's preference in how the user would like to assess the organizations.

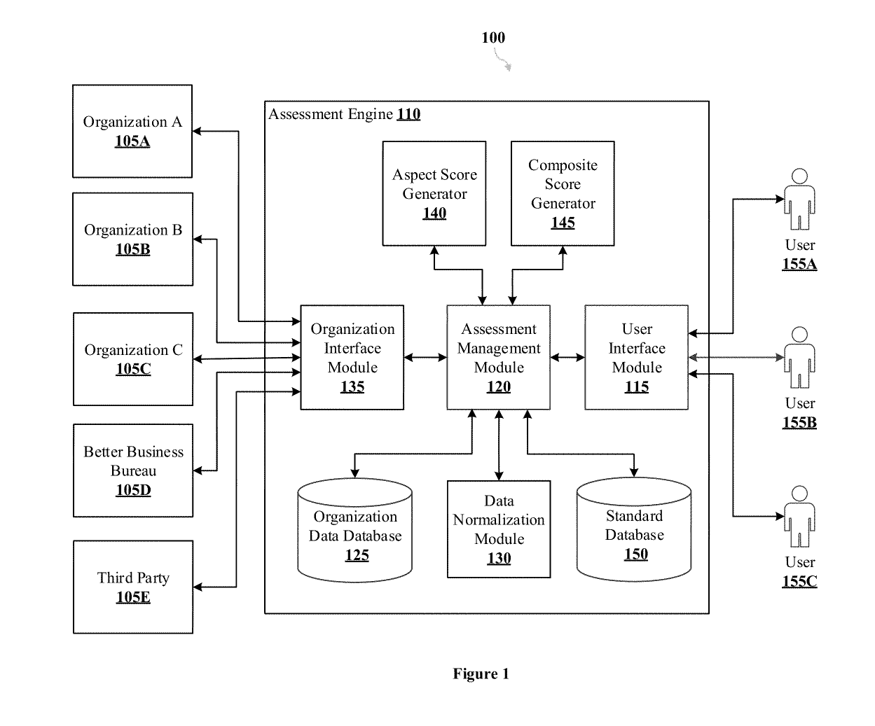

FIG. 1 illustrates an example organization assessment system 100. The organization assessment system 100 includes an assessment engine 110. The assessment engine 110 is communicatively coupled with multiple organizations (organizations 105A-105C) and/or other third party entities (third parties 105D-105E) to obtain performance data of different organizations. The assessment engine 100 is also communicatively coupled with several users (e.g., users 155A-155C) to provide assessment output to these users.

In some embodiments, the assessment engine 110 includes an assessment management module 120, an organization data database 125, a data normalization module 130, a standard database 150, an aspect score generator 140, and a composite score generator 145. The assessment engine 110 may also include an enterprise interface module 135 configured to interface with the organizations 105A-105C and third parties 105D-105E, and a user interface module 115 configured to interface with one or more user computers 155A-155C.

In some embodiments, the organization assessment system 100 may be operated and administered by personnel of an organization for assessing the performance of that same organization. Organization personnel may be tasked with producing an assessment report of the organization. In other embodiments, the organization assessment system 100 may be operated and administered by personnel of a completely impartial entity (e.g., an independent organization evaluation agency, such as Forbes®, U.S. News and Reports®, etc.). The impartial entity may be in the consulting services business, specializing in the evaluation of companies or other organizations. As shown, the user interface module 115 may communicate with multiple users 155A-155C (e.g., organization managers, third party assessment entity employees, potential investors, potential partners, etc.) who may have a vested interest in obtaining organization assessment information or reports. The users 155A-155C may communicate with the organization assessment system 100 over a network (e.g., a Local Area Network (LAN), a Wide Area Network (WAN), the Internet, etc.).

In some embodiments, the organization data database 125 may be a permanent data storage such as a hard drive, a flash memory, etc. The organization data database 125 stores organization information (e.g., name, identifier, address, number of employees, etc.), and performance data of different organizations. Performance data is data that is used to measure the performance level of the organization from many different aspects (e.g., financial aspects, customer relationship aspects, employee aspects, shareholder aspects, vendor aspects, etc.). Examples of performance data include: financial data (e.g., balance sheets, income statements, etc.), product quality data, product defect/recall data, customer complaints data, product reviews by customers, employee surveys, vendor relationship data, charitable donation data, project management data, etc.

Performance data may be retrieved from multiple data sources. For example, the assessment engine 110 may retrieve performance data of an organization from the organization itself via the organization interface module 135. In some of these embodiments, the assessment engine 110 can be communicatively coupled with the organization's network of computing devices and automatically monitor, track, and retrieve the performance data from the organization's network. The assessment engine 110 may also retrieve performance data of an organization from third parties that report performance data of different organizations, such as obtaining customer complaint data from the Better Business Bureau.

In addition, performance data may be received in different formats (e.g., Hyper-Text Markup Language (HTML) posts, Extensible Markup Language (XML) data files/posts, plain text format, etc.). The organization data database 125 in some embodiments may be fully integrated with the organization assessment system 100. In other embodiments, the organization data database 125 may be partially or totally setup separately from the organization assessment system 100. The organization data database 125 may also be communicatively coupled with the assessment engine 110 over a network (e.g., a Local Area Network (LAN), a Wide Area Network (WAN), the Internet, etc.).

In some embodiments, the assessment engine 110 is configured to retrieve performance data of several organizations (e.g., companies, universities, etc.) from the multiple sources 105A-105E on a regular basis. For example, the assessment engine 100 may be configured to periodically poll performance data from the sources 105A-105E. As mentioned, a direct source of performance data may be any one of the multiple enterprise entities 105A-105C. Alternatively, the sources 105A-105E may be set up to push performance data to the assessment engine 110 via the organization interface module 135 whenever the performance data is updated. Once the performance data is retrieved, the assessment management module 120 is configured to store the performance data in the organization data databases 125.

In some embodiments, the assessment management module 120 may instruct the data normalization module 130 to first reformat and normalize the retrieved raw performance data before storing the data in the organization data database 125. The data normalization module 130 may reformat the raw performance data of the different organizations in a common format (e.g., a common XML format). The performance data being in different formats, the performance data may also be on different scales from the different organizations. For example, the way different organizations score the management of a project may be on different scales (e.g., on a scale of 0-100 vs. a scale of outstanding, good, fair, and poor). Thus, the normalization module 130 may also normalize the raw performance data so that the performance data from different organizations may be on the same common scale. Thereby, the normalized performance data allow for effective comparison among the performance data and ranking of the organizations based on their performance data. The normalization module 130 then stores the normalized performance data in the organization data database 125.

It is contemplated that an organization may be assessed according to different metrics and criteria. For example, an organization may be assessed based on its financial strength or its relationship with its customers. It is also contemplated that different parties who have vested interest in the organization are interested in different aspects of the organization. For example, a short-term potential investor of an organization might only be interested in the financial aspect of the organization but another long-term potential investor might be interested in looking at a broader picture and value the organization's project management aspect, vendor/customer/employee relationship aspects as an indication of potential growth more than its short-term financial aspect. A first organization who is interested in partnering with a second organization might also be interested in look at some of the attributes of the second organization (i.e., ethical aspect, employee relationship aspect, customer/vendor relationship aspect, etc.) to determine if the second organization share the same vision as the first organization.

Thus, once normalized performance data of an organization is stored in the organization data database 125, the assessment management module 120 of some embodiments would instruct the aspect score generator 140 to generate, for the organization, different aspect scores that correspond to different aspects of the organization. To generate the different aspect score, the aspect score generator 140 must retrieve the performance data of the organization that is determined to be related to the aspect, and combine the data to compute an aspect score. In some embodiments, the aspect score is being computed using a pre-determined formula (algorithm) that takes into account all the relevant performance data.

There are different ways for the assessment engine 110 to determine which types of performance data are relevant to each aspect of the organization. For example, an administrator of the organization assessment system 100 may manually provide this information to the assessment engine 110 and have it store in a non-transitory storage such as a hard drive. In some embodiments, the aspect score generator 140 may have some artificial intelligence to use the metadata of the performance data (e.g., the “type” or “label” of the performance data, etc.) to categorize the data and determine to which aspect(s) the performance data is relevant.

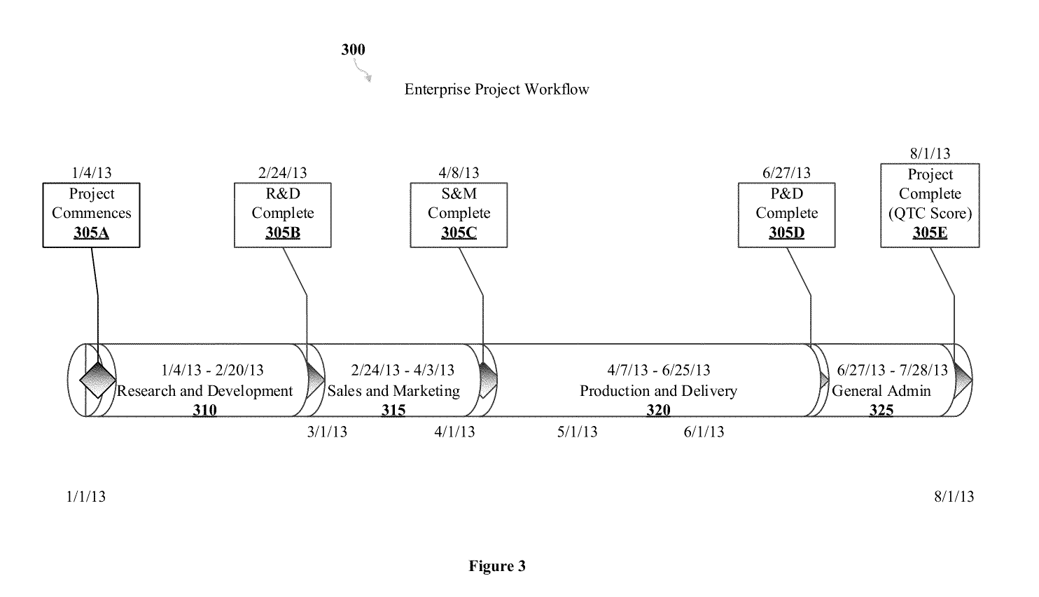

In some embodiments, the standard database 150 may be a permanent data storage such as a hard drive, a flash memory, etc. It is contemplated that the standard database 150 may store data related to different standards that may be utilized to any one of the different aspect scores, upon the directives of the user. For example, the standard database 150 may store one standard that defines the methodology to derive a project planning performance aspect score. This methodology may include one or more formulas, which may then be applied to normalized performance data to derive the project planning aspect score. One of the formulas utilized by such methodology may be to calculate the fluctuation of the level of productivity at any time between the beginning and end of the different phases of a project (as illustrated further in FIG. 3 below). The level of productivity (based on the time, cost, and quality of work performed) could be represented by P. Therefore, by way of an example, for the Research and Development phase of the project there may be a first value for P at the beginning of the phase, and a second value for P at the end of the phase. Accordingly, the fluctuation of P for that phase of the project would be represented by AP. The same methodology may be applied to any of the other phases of the project, in conformance to the user selected standard.

In some embodiments, the user may be given the option to choose from among a plurality of standards stored in the standard database 150. Upon the user's selection of a standard to derive a given aspect score, the assessment management module 120 may communicate the user specified standard to the aspect score generator 140. Thereupon, the aspect score generator 140 may utilize the same selected standard to carry on the necessary steps, as dictated by the selected standard, to derive the specified aspect score.

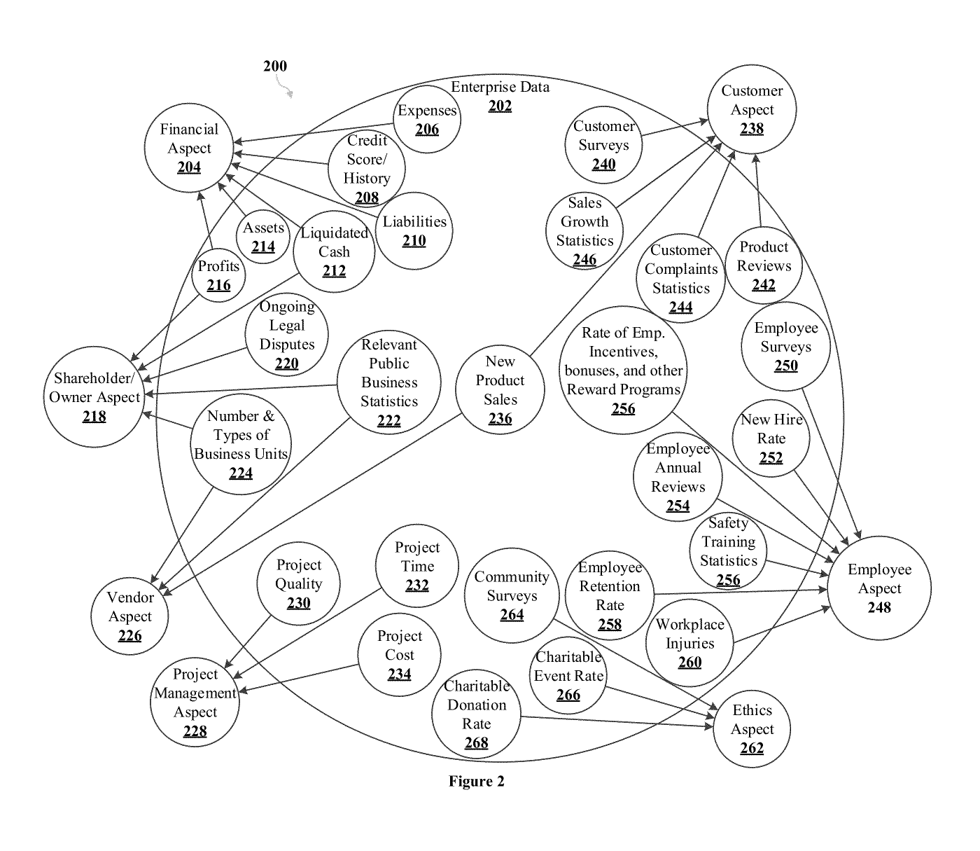

FIG. 2 illustrates an example performance data set 202 for a business enterprise that may be retrieved by the assessment engine 110. The performance data set 202 only represents an exemplified performance data set, and different embodiments may include additional data of the business enterprise to be in the set 202. The performance data set 202 for the business enterprise may include data from different facets of the enterprise, which may include financial data such as expense data 206, credit score/history data 208, liability data 210, liquidated cash data 212, assets data 214, and profits data 216. The performance data set 202 also includes general business data such as number and types of business units data 224, ongoing legal dispute data 220, and other relevant public business statistics data 222. The performance data set 202 may also include production related data such as new product sales data 236, product reviews data 242, and sales growth data 246.

In addition, the performance data set 202 may include customer related data such as customer satisfaction survey data 240 and customer complaint statistics data 244. Furthermore, the performance data set 202 may include employee related data such as employee satisfaction surveys data 250, new hire rate 252, employee annual review data 254, employee safety training statistics data 256, employee retention rate data 258, and workplace injuries data 260. The performance data set 202 may also include data related to how the organization reach out to its community, such as community surveys data 264, charitable event rate data 266, and charitable donation rate data 268. The performance data set 202 may also include project management data such as project quality data 230, project completion time data 232, and project cost data 234.

As mentioned above, the aspect score generator 140 is configured to quantify different aspect scores related to different performance aspects of the enterprise based on the set of data 202. First, the aspect score generator 140 identifies a set of aspects for the organization, such as financial aspect 204, shareholder/owner aspect 218, vendor aspect 226, project management aspect 228, customer aspect 238, employee aspect 248, and ethics aspect 262.

The aspect score generator 140 then determines which performance data is related to each of the different aspects in order to generate the respective aspect scores. For example, the aspect score generator 140 may determine that the financial aspect score 204 would take into account performance data such as expenses of operations 206, credit score/history data 208, liabilities data 210, data regarding available liquidated cash of the organization 212, asset data 214, and profit data 216. The aspect score generator 140 may determine that the shareholder/owner aspect score would take into account performance data such as profits data 216, liquidated cash data 212, data regarding legal disputes in which the organization is a party 220, relevant public business statistics data 222, and number & types of business units data 224. As shown, some of the performance data may be relevant to more than one aspect. For example, profits data 216 and liquidated cash data 212 are relevant to both the financial aspect score 204 and the shareholder/owner aspect score 218.

The aspect score generator 140 may determine that the vendor aspect score 226 would take into account performance data such as new product sales data 236, relevant public business statistics data 222, and number & types of business units data 224. The vendor aspect score may be used for the specific purposes of vendors dealing with the assessed organization, in some embodiments.

The aspect score generator 140 may determine that the project management aspect score 228 would take into account project quality data 230, project completion time data 232, and project cost data 234. The project management aspect score may be of interest to users such as organization executives, middle management, etc. This category of users may use this aspect score to assess current operational and functional efficiency of the assessed organization. In these embodiments, the project management aspect score 228 may be calculated using project quality, time, and cost (QTC) data, as will be illustrated further with FIG. 3 below.

The aspect score generator 140 may calculate the ethics aspect score 262 using any data related to the charitable donations made by the organization 268, data regarding any charitable events organized by the organization 266, other data gathered through community surveys 264, etc. User who may be interested in assessing an organization from this prospective may include organization's shareholders/owners, potential investors, other third parties who have an interest in evaluating the organization's operations for any purpose, etc.

The aspect score generator 140 may also determine that the employee aspect score 248 would take into account performance data such as data related to workplace injuries 260, employee retention rate in the organization 258, safety training statistics 256, annual reviews 254 or employee incentives/bonuses 256, new hire rate 252, and employee surveys 250. The aspect score generator 140 may also determine that the customer aspect score 238 may be computed using performance data such as any product reviews data 242, customer complaints statistics 244, sales growth statistics 246, customer surveys data 240, and also new products sales data 236.

The aspect score generator 140 may then take the relevant data to compute (quantify) an aspect score for each of the different aspects. Each aspect score is computed to indicate how well the organization performs with respect to the corresponding aspect. For example, a high financial aspect score would indicate that the organization is performing well financially. Similarly, a high customer aspect score indicates that the organization treats its customers well, and its customers are generally satisfied with the products/services offered by the organization. It is contemplated the selection of performance data for each aspect may affect the accuracy and relevancy of the aspect score. Generally, the more data the aspect score generator 140 uses for each aspect, the more accurate the score reflects the actual performance of the organization.

Once the different aspect scores are generated by the aspect score generator 140, they are stored in the organization data database 125 for future use. A user who has vested interest in one or more organizations may use the organization assessment system 100 to assess, compare, and/or rank different organizations. It is contemplated that different users have different criteria in assessing organizations. For example, when assessing a business enterprise, some only consider the financial aspect of the enterprise while others might take a broader approach and look at all of the different aspects (financial aspect, shareholder aspect, customer aspect, employee aspect, project management aspect, and ethics aspect). However, even for the parties who look at all aspects of the organization, each might put different weights on the different aspects. For example, one party (e.g., a potential investor) may consider the financial aspect more important than the other aspects while another party (e.g., a potential employee) may consider the employee aspect more important.

Thus, the assessment engine 110 allows different users (e.g., users 155A-155C) to provide their preferences of assessing organizations in computing the composite score for the organizations, including which aspect(s) they would like to select and what weight to be put on each selected aspect. In some embodiments, the assessment engine 110 may provide a user interface to the users via the user interface module 115. The user interface may provide tools (e.g., drop down menu, text boxes, etc.) for the users to select one or more aspects of the organizations they would like to consider in the composite score. The user interface may also provide tools (e.g., sliding bars, etc.) that allow the users to specify how much weight to give to each selected aspect.

Once the user's preference is received, the assessment management module 120 would instruct the composite score generator 145 to generate composite scores for one or more organizations based on the user's preference. The composite score combines the aspect scores that correspond to the aspects selected by the user and gives different weights to the different aspect scores according to the user's indication via the user interface. The assessment management module 120 then presents the composite scores of the organizations to the user via the user interface module 115. In some embodiments, the assessment management module 120 also presents a ranking of the organizations according to their composite scores to the user.

TABLE 1

| | Enterprise “A” | Enterprise “B” |
|---|---|---|
| Financial Aspect | 90 | 65 |
| Owner Aspect | 85 | 80 |
| Customer Aspect | 30 | 85 |
| Employee Aspect | 20 | 80 |
| Vendor Aspect | 25 | 85 |
| Ethics Aspect | 10 | 70 |

For example, Table 1 illustrates different aspect scores that have been computed by the organization assessment system 100 for two different enterprises—Enterprise “A” and Enterprise “B”. These aspect scores were computed using performance data related to the respective enterprises. As shown, Enterprise “A” has a financial aspect score of 90, an owner aspect score of 85, a customer aspect score of 30, an employee aspect score of 20, a vendor aspect score of 25, and an ethics aspect score of 10. These aspect scores show that Enterprise “A” is likely to be very profitable, indicated by the high financial aspect score, but that Enterprise “A” might have problems with retaining customers, employees, and vendors. On the other hand, Enterprise “B” has a financial aspect of 65, an owner aspect score of 80, a customer aspect score of 85, an employee aspect score of 80, a vendor aspect score of 85, and an ethics aspect score of 70. These aspect scores show that Enterprise “B” is likely to be reasonably profitable (though not as profitable as Enterprise “A”), and most of the stakeholders (e.g., the owner, customers, employees, and vendors) are generally pretty satisfied with Enterprise “B”.

As mentioned before, different users who would like to assess organizations using different criteria would get different results using the organization assessment system 100. In this example, a first user whose interest is solely on the short-term profitability of different enterprises (e.g., a short-term trader) would select financial aspect and owner aspect to be used in computing the composite score, and assigns a large portion (e.g., 70%) of weights to the financial aspect and a smaller portion (e.g., 30) of weights to the owner aspect. Using these inputs, the assessment engine 110 would generate a composite score of 88.5 for Enterprise “A” and a composite score of 69.5 for Enterprise “B”. Thus, the assessment engine 110 would rank Enterprise “A” higher than Enterprise “B” for the first user.

On the other hand, a second user whose interest is looking for a long term partner would select financial aspect, employee aspect, vendor aspect, customer aspect, and ethics aspect to be used in computing the composite score, and assigns approximately equal portions of weights (e.g., 20% for each aspect). Using these inputs, the assessment engine 110 would generate a composite score of 35 for Enterprise “A” and a composite score of 77 for Enterprise “B”. Thus, the assessment engine 110 would rank Enterprise “B” higher than Enterprise “A” for the second user.

As mentioned above, the assessment engine 110 can be configured to monitor, track, and retrieve performance data from an organization by tapping into the organization's internal network. In some embodiments, the assessment system 100 also includes a performance data tracking module that resides within the organization's internal network for monitoring, tracking, and sending the tracked data back to the assessment engine 110. FIG. 3 illustrates an example of how the performance data tracking module tracks performance data related to project management of an organization. Specifically, FIG. 3 illustrates the operation of tracking performance data through a project lifecycle 300. Additionally, FIG. 3 illustrates one example methodology that may be used to derive the project management aspect score. As shown, the project lifecycle 300 includes multiple phases: a research and development (R&D) phase 310, a sales and marketing phase 315, a production and delivery phase 320, and a general administration phase 325.

At the time (or prior to) the project commences on Jan. 4, 2013 (checkpoint 305A), the performance data tracking module can collect data related to the estimated time and cost for each of the phases 310-325. At the completion of each phase (such as checkpoint 305B when R&D phase 310 is completed, checkpoint 305C when sales and marketing phase 315 is completed, checkpoint 305D when production and delivery phase 320 is completed, and checkpoint 305E when general administration phase 325 is completed), the performance data tracking module is configured to track the actual time being spent and the actual cost being used in the immediately preceding phase. In addition to time and cost, the performance data tracking module can also track the quality of any output from each phase. For example, at checkpoint 305B, the performance data tracking module would track the actual time being spent and the actual cost being used in the R&D phase, and also the quality of any output from the R&D phase 310 (e.g., product design, marketing plan, etc.). The performance data tracking module would then send this performance data (including the estimated time/cost and the actual time/cost for the R&D phase) to the assessment engine 110. The performance data tracking module is configured to perform the same tracking and transmitting of performance data at the other checkpoints 305C-305E until the project lifecycle is completed.

The aspect score generator 140 can take this raw performance data to calculate an aspect score associated with the project management aspect for the enterprise. As mentioned, the aspect score generator 140 may employ different standards to calculate the aspect score associated with the project management aspect discussed here. The user may specify any one of many standards to compute the project management aspect score. FIG. 3 illustrates one such example. In some embodiments, the aspect score generator 140 is configured to compute the project management aspect score based on the difference between the estimated time and cost and the actual time and cost for each phase during the project lifecycle 300 and also for the project as a whole. The aspect score is also based on the quality of any output from each phase, and the output for the entire project.

The example illustrated in FIG. 3 demonstrates how the organization assessment system 100 may help to track and evaluate different project management methodologies. Additionally, these assessment tools may help the organization to target efforts to improve certain areas of a project management methodology as needed. For example, if the project management aspect score indicate a need to improve on the amount of time being used to perform the implementation of project functions or features, the project manager may adjust accordingly to improve with regards to project implementation time. Similarly, the project manager may take any necessary steps to adjust by improving the quality of work performed (based on the definition of the project's “quality’), or to improve project processes with regards to cost of operation.

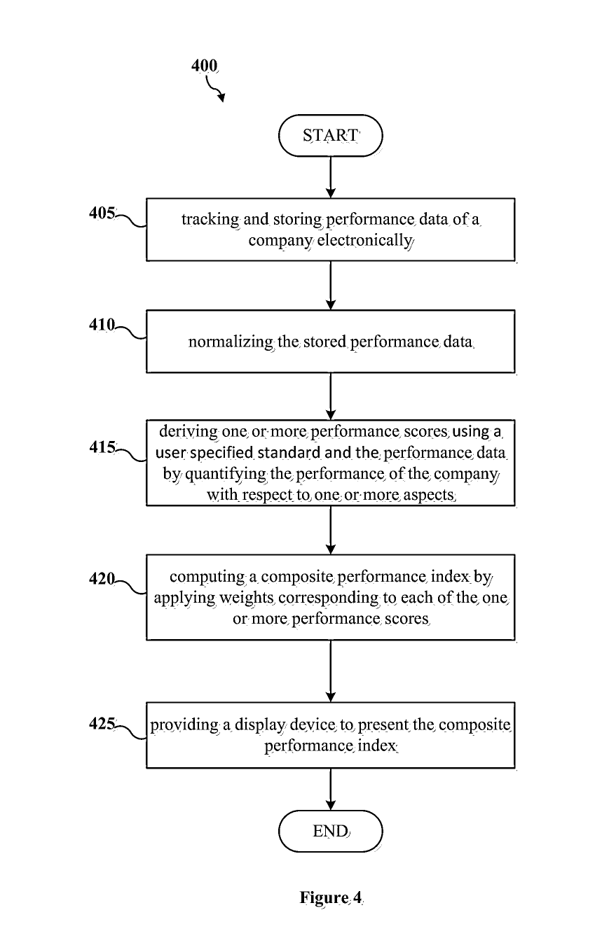

The present invention provides for methods to achieve the features discussed above. FIG. 4 illustrates a preferred embodiment of a process for assessing the performance of an organization. The method 400 will now be described by reference to FIG. 1. In step 405, performance data of an organization is electronically tracked and stored. The assessment management module 120 may receive raw performance data using the enterprise interface module 135, and may store this data in the organization data database 125.

In step 410, the organization assessment system 100 may reformat the stored performance data in its original raw format to a format specifically designed to optimize assessment functionality of the organization assessment system 100. Also as discussed, in these embodiments the assessment management module 120 may instruct the data normalization module 130 to perform data normalization over the raw performance data (such that data from different organizations will be on the same scaled for comparison purposes). The assessment management module 120 may then store the data in its normalization form in the organization data database 125.

In step 415, the organization assessment system 100 may derive one or more aspect scores from the normalized performance data. In some embodiments, each of the aspect scores are derived by quantifying organization performance data that is relevant to the corresponding aspect. In these embodiments, the assessment management module 120 may instruct the aspect score generator 140 to calculate aspect scores (or aspect scores) using performance data that has been identified as relevant to the respective aspects. It is contemplated the user may be able to select a specific standard to be used in calculating any one of the one or more aspect scores. In these embodiments, the assessment management module 120 may notify the aspect score generator 140 of the user selected standard prior to instructing the aspect score generator 140 to carry on the calculation of any one of the aspect score.

In step 420, the organization assessment system 100 provides for computing a composite performance index by applying the user specified weights to the different performance scores. In some embodiments, the assessment management module 120 may receive input from each user through the user interface module 115, the input to indicate weights to the different aspects.

Finally, in step 425, the organization assessment system 100 may provide for a display device to present the computed composite performance index. In some embodiments, the assessment management module 120 may instruct the user interface module to present the derived composite performance index to the user 155A-155C.

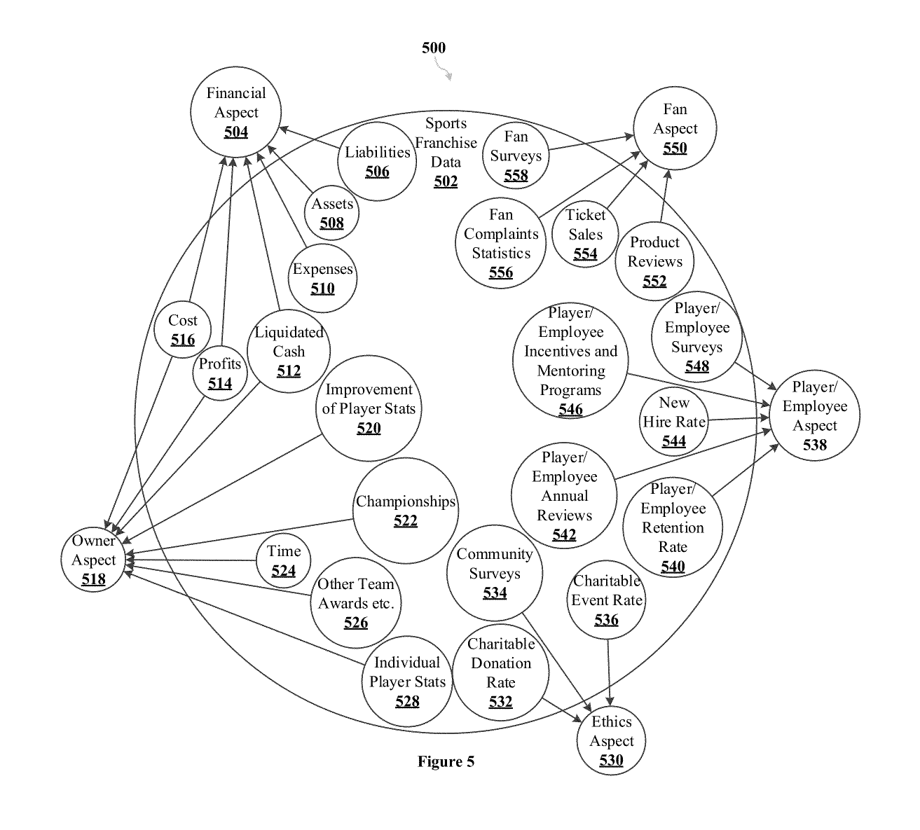

FIG. 2 illustrated exemplary performance data of, and aspects relevant to, a business enterprise. The organization assessment system 100 may be configured to assess different types of organizations as well, such as educational institutes, sport franchises, etc. It is contemplated that different types of performance data and different types of aspects are relevant to different types of organizations. FIG. 5 illustrates an example performance data set 502 that may be retrieved for a sports franchise (i.e., a sports team). As discussed with regards to the enterprise performance data set 202, multiple aspect scores may be utilized to measure performance of the sports franchise, using the franchise performance data set 502. The multiple aspect scores of some embodiments may include a financial aspect 504, an owner aspect 518, an ethics aspect 530, a player/employee aspect 538, and a fan aspect 550. Other embodiments may include sports franchise data elements that may be used to determine any one of a myriad of other relevant aspects, as may be required by any corresponding users.

As discussed with regards to the enterprise performance data set 202, the aspect score generator 140 may calculate a financial aspect 504 using sports franchise data such as expenses of operations 510, liabilities data 506, data regarding available liquidated cash of the franchise 512, asset data 508, profit data 514, and other cost data 516. The financial aspect 504 of a sports franchise may be of interest to specific users (e.g., team owners, franchise executives, members of the executive office, etc.)

In some embodiments, the aspect score generator 140 may determine the owner aspect score 518 by using profits data 514, liquidated cash data 512, data regarding the assets of the franchise 508, data regarding the liabilities 506, expenses 510, and other cost 516 of operation. In addition, the owners aspect score 518 may also be determined using data regarding the improvement in players' performance 520, championships won by the franchise 522, duration of yielding results and other sport accomplishments 524, data on other team awards etc. 526, data regarding current players statistics 528, in some other embodiments.

In some embodiments, the aspect score generator 140 may determine the ethical aspect score 530 using data related to the charitable donations made by the franchise 532, data of any charitable events organized by the franchise 536, and data gathered through community surveys 534. Users interested in the ethical aspect score 530 may include team owners, corresponding sports commission official, other third party assessment services providers, etc.

Another relevant aspect in some embodiments may be a player/employee aspect score 538. In these embodiments, the aspect score generator 140 may calculate the player/employee aspect score 538 using data related to player/employee retention rate 540, player/employee annual reviews 542, new hire rate 544, player/employee incentives and mentoring programs 546, and player/employee surveys 548. The player/employee aspect score 538 may be relevant to another category of users, as its name suggest, including team executives, management, team players, other categories of franchise employees, etc. This category of users may be interested in the player/employee aspect score to assess the player/employee satisfaction, ways to improve utilization of human resources of the franchise, etc.

Yet another critical aspect that may be assessed in some embodiments is the fan aspect score 550. Data gathered through fan surveys 558, statistics regarding fan complaints 556, ticket sales 554, and franchise products reviews 552, may be used by the aspect score generator 140 to calculate the fan aspect score 550. Examples of users that may select and utilize the fan aspect score 550 in their franchise assessment process, may include franchise owners, franchise executives, other potential franchise owners, etc. The fan aspect score 550 may serve to give these users indicators regarding the popularity of the franchise, it reputation among the fan based of the corresponding sport, general success as compared to other franchises, etc.

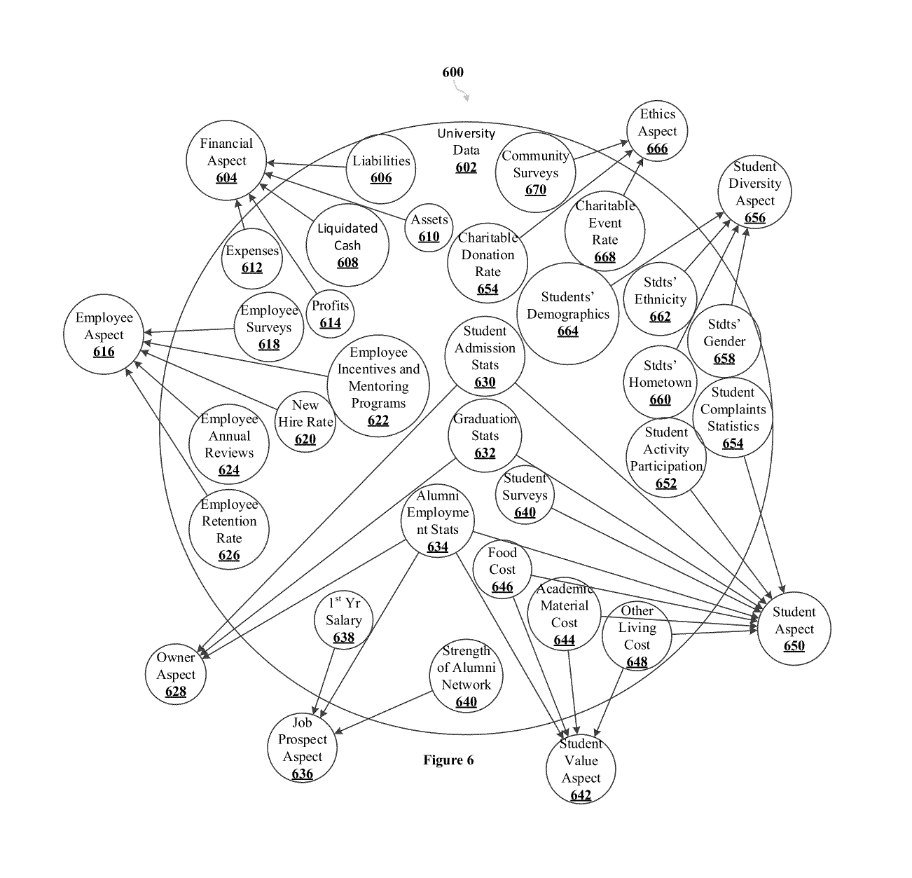

FIG. 6 illustrates yet another example performance data set 602 that may be retrieved for an educational institution (e.g., a university). As discussed with regards to the enterprise performance data set 202 and the sports franchise performance data set 502, multiple aspect scores may be utilized to evaluate the university's performance, and may be calculated using the university performance data set 602. The multiple aspect scores of some embodiments may include a financial aspect 604, an employee aspect 616, an owner aspect 628, a job prospect aspect 636, a student value aspect 642, a student aspect 650, a student diversity aspect 656, and an ethics aspect 666. Other embodiments may include additional relevant aspects scores as may be required by any corresponding users.

In some embodiments, the aspect score generator 140 may determine a financial aspect score 604 using performance data such as expenses of operations 612, liabilities data 606, data regarding available liquidated cash of the university 608, asset data 610, and profit data 614. As discussed with regards to enterprise and sport franchise entities, the financial aspect score 604 of a university may be of interest to specific users (e.g., university dean, registrar office personnel, board of directors, etc.)

In other embodiments, the aspect score generator 140 may calculate the employee aspect score 616 using performance data related to employee retention rate 626, employee annual reviews 624, new hire rate 620, employee incentives and mentoring programs 622, and employee surveys 618. The employee aspect score 616 may be of interest to a category of users that may include the board of directors, university dean, etc. This category of users may be interested in the employee aspect score 616 to assess employee satisfaction, ways to improve human resource utilization, etc.

In some embodiments, the aspect score generator 140 may calculate the owner aspect score 628 using data related to student admissions statistics 630, graduation statistics 632, and alumni employment statistics 634. The alumni employment statistics 634 may also be used to generate a student value aspect score 642. The job prospect aspect score 636 may be calculated using data regarding the first year salary of university alumni 638, strength of the alumni network 640, and alumni employment statistics 634. The alumni employment statistics 634, university date related to cost of food 646, academic material 644, and other living expenses 648, may be utilized to calculate the student value aspect score. In addition, the owner aspect score 628 may be calculated using data related to student admissions statistics 630, graduation statistics 632, and alumni employment statistics 634.

In some embodiments, the aspect score generator 140 may determine the student aspect score 650 using university performance data including the same data elements utilized to calculate the student value aspect score and the owner aspect score. Additionally, the student aspect score 650 may be calculated using university performance data collected via various student surveys 640 (e.g., student surveys related to student satisfaction, education cost affordability, student extra-curricular activities, etc.). Furthermore, university performance data related to student participation in various types of university activities 652, and data related to statistics regarding student complaints of any type 654 may also be used to calculate student aspect score 650.

In yet other embodiments, the aspect score generator 140 may determine the student diversity aspect score 656 using university data including statistics of the ratios of student gender 658, student ethnicity 662, student hometown 660, and student demographics 664. In some embodiments, the owner aspect score 628, the job prospect aspect score 636, the student value aspect score 642, the student aspect score 650, and the student diversity aspect score 656 may play a factor of varying degrees/weights to different categories of users. These categories of users may include the owner(s) of the university, the board of directors of the university, the student body or any type of student association, any third party body that may have an interest in rating the university, etc. These users may consider the aforementioned aspects scores, by specifying different weights to the different aspects scores, so as to provide the required flexibility and accuracy in assessing the university from the corresponding prospective of each user.

Similar to enterprise and sports franchise entities, users may be interested in evaluating the university from an ethical aspect. In these embodiments, the aspect score generator 140 may determine the ethical aspect score 666 using any data related to the charitable donations made by the university 654, data of any charitable events organized by the university 668, and data gathered through community surveys 670. This category of users may include accreditation authorities, board of directors, office of the dean, potential students, university alumni, other third party assessment services providers, etc.

As discussed, the above example performance data sets require a certain flexibility as retrieved and utilized by the organization assessment system 100. Therefore, this present invention includes a method, which provides for the required generic and flexible processing of any organization performance data, to serve the assessment purposes of any user of the system.

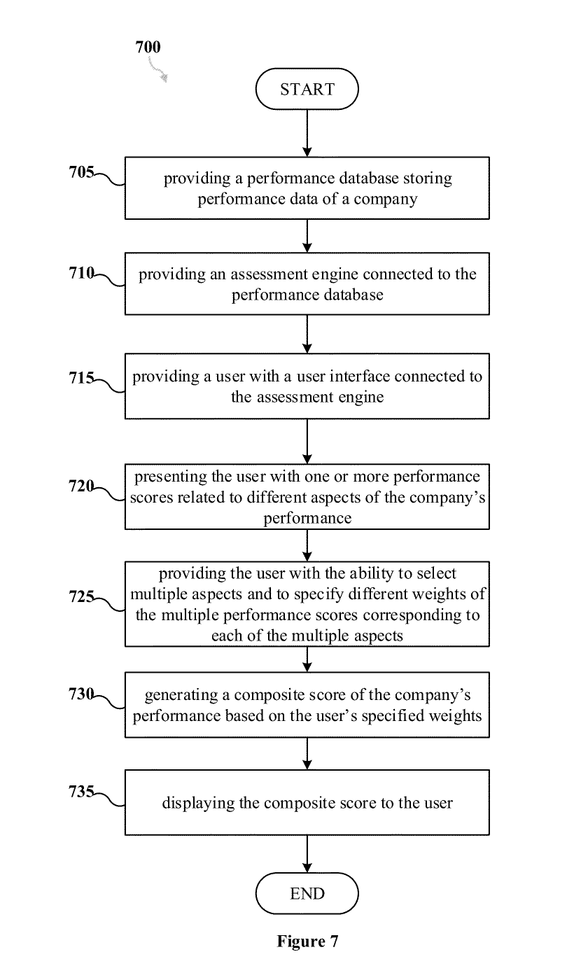

FIG. 7 illustrates a preferred embodiment of a process for assessing an organization using user-defined criteria. The process 700 will now be described by reference to FIG. 1. In step 705, the organization assessment system 100 provides a organization data database 125 for storing the performance data of an organization. The organization assessment system 100 may also provide an assessment engine 110 that may be connected to the organization data database 125, as described in step 710. In step 715, the organization assessment system 100 may provide a user interface 115 that may be connected to the assessment engine 110.

In some embodiments, the organization assessment system 100 may present a user 155A-155C with one or more performance scores related to different aspects of the organization's performance, as in step 720. In these embodiments, the assessment management module 120, of the assessment engine 110, may instruct the user interface module 115 to present performance scores to the user 155A-155C.

In step 725, the user 155A-155C may be presented with the ability to select multiple aspects and to specify different weights for each of the multiple performance scores corresponding to each of the multiple aspects. In these embodiments, the assessment management module 120 may use the user interface module 115 to gather input from the user 155A-155C including user specified weight for each corresponding performance score. The assessment management module 120 may then communicate user specified weights to the composite score generator 145.

In step 730, the organization assessment system 100 may generate a composite score of the organization's performance based on the user's specified weights. In some embodiments, the assessment management module 120 may use the composite score generator 145 to calculate the composite score. Finally, in step 735, the organization assessment system 100 may present the generated composite score to the user. Specifically, the assessment management module 120, of some embodiments, may use the user interface module 115 to present the composite score to the user 155A-155C.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of assessing an organization using user-defined criteria, comprising:
providing a performance database configured to store performance data of the organization;
providing an assessment engine coupled to the performance database;
deriving, by the assessment engine, a first aspect score and a second aspect score for the organization based on the performance data, wherein each of the first and second aspect scores quantifies a different performance aspect of the organization;
providing a user interface that allows a user to specify a weight for each performance aspect;
generating a composite score for the organization by applying corresponding ones of the weights to each of the first and second aspect scores; and
configuring a display device to present the composite score to the user.

2. The method of claim 1, wherein the first aspect score quantifies a performance aspect of the organization with respect to a first stakeholder, and the second aspect score quantifies a performance aspect of the organization with respect to a second stakeholder different from the first stakeholder.

3. The method of claim 2, wherein each of the first and second stakeholders is selected from the following group of stakeholders: customers, vendors, employees, and shareholders.

4. The method of claim 1, further comprising deriving, by the assessment engine, a third aspect score based on the performance data that quantifies a performance aspect of the organization with respect to a third stakeholder, wherein the composite score is further based on a weighting of the third aspect score.

5. The method of claim 4, further comprising deriving, by the assessment engine, a fourth aspect scores based on the performance data that quantifies a performance aspect of the organization with respect to a fourth stakeholder, wherein the composite score is further based on a weighting of the fourth aspect score.

6. The method of claim 5, further comprising deriving, by the assessment engine, a fifth aspect scores based on the performance data that quantifies a performance aspect of the organization with respect to a fifth stakeholder, wherein the composite score is further based on a weighting of the fifth aspect score.

7. The method of claim 1, wherein the first aspect score is based on a first subset of the performance data, and the second aspect score is based on a second subset of the performance data different from the first subset.

8. The method of claim 1, wherein the performance data comprises at least four of the following: financial data, customer satisfaction data, vendor satisfaction data, employee satisfaction data, electronic communication among employees, electronic communication between employees and vendors, electronic communication between employees and customers, and project tracking data.

9. The method of claim 1, wherein the user interface allows the user to select a weighting profile from a plurality of weighting profiles, wherein each weighting profile in the plurality of weighting profiles specifies weights for the different performance aspects.

10. The method of claim 9, wherein the plurality of weighting profiles comprises a vendor weighting profile, a partnership weighting profile, a merger and acquisition weighting profile, and a customer weighting profile.

11. The method of claim 1, further comprising providing a second user interface that allows the user to specify first and second performance aspects from among the different performance aspects, to be quantified by the first and second aspect scores, respectively.

12. The method of claim 1, wherein the performance database is further configured to store performance data of a plurality of companies.

13. The method of claim 12, further comprising:
deriving, by the assessment engine, a first aspect score and a second aspect score for each organization in the plurality of companies;
generating a composite score for each organization in the plurality of companies by applying the corresponding weight to each of the first and second aspect scores and combining a weighted first aspect score with a weighted second aspect score for each organization;
ranking the plurality of companies according to the composite scores; and
configuring a display device to present the ranking of the plurality of companies.

14. A system for assessing a organization using user-defined criteria, comprising:
a performance database configured to store performance data of the organization;
an assessment engine coupled to the performance database, the assessment engine configured to:
derive a first aspect score and a second aspect score for the organization based on the performance data, wherein each of the first and second aspect scores quantifies a different performance aspect of the organization;
provide a user interface that allows a user to specify a weight for each performance aspect;
generate a composite score for the organization by applying corresponding ones of the weights to each of the first and second aspect scores; and
configure a display device to present the composite score to the user.

15. The system of claim 14, wherein the first aspect score quantifies a performance aspect of the organization with respect to a first stakeholder, and the second aspect score quantifies a performance aspect of the organization with respect to a second stakeholder different from the first stakeholder.

16. The system of claim 15, wherein each of the first and second stakeholders is selected from the following group of stakeholders: customers, vendors, employees, and shareholders.

17. The system of claim 14, wherein the user interface allows the user to select a weighting profile from a plurality of weighting profiles, wherein each weighting profile in the plurality of weighting profiles specifies weights for the different performance aspects.

18. The system of claim 17, wherein the plurality of weighting profiles comprises a vendor weighting profile, a partnership weighting profile, a merger and acquisition weighting profile, and a customer weighting profile.

19. The system of claim 14, wherein the assessment engine is further configured to provide a second user interface that allows the user to specify first and second performance aspects from among the different performance aspects, to be quantified by the first and second aspect scores, respectively.

20. A method of assessing a performance of an organization, comprising:
electronically tracking performance data of an organization;
deriving, from the performance data, a first performance score quantifying a performance of the organization with respect to a first stakeholder;
deriving, from the performance data, a second performance score quantifying a performance of the organization with respect to a second different stakeholder;
computing a composite performance index for the organization by applying a first weight to the first performance score and a second weight to the second performance score based on a weighted first score and a weighted second score; and
configuring a display device to present the performance index to a user.
